(19) United States
(12) Patent Application Publication
(10) Pub. No.: US 2014/0325970 A1
(43) Pub. Date: Nov. 6, 2014

(54) IMPACT ENERGY CONVERSION DEVICE

(71) Applicant: Piotr Mitre Radowski, Gdynia (PL)

(72) Inventor: Piotr Mitre Radowski, Gdynia (PL)

(21) Appl. No.: 14/239,655

(22) PCT Filed: Jul. 1, 2011
(86) PCT No.: PCT/PL2011/000068

§ 371 Date: Feb. 19, 2014

(30) Foreign Application Priority Data
Apr. 4, 2011 (PL) P-394444

(51) Int. Cl. F16F 9/06; B60R 19/34

(52) U.S. Cl. CPC F16F 9/06; B60R 19/34
USPC 60/325; 188/269; 293/133

(57) ABSTRACT

An impact energy conversion device, designed particularly for a car bumper comprises cylinders and at least one confusor (4), where each confusor (4) is, at its inlet, connected to the main hydraulic cylinder (6) fitted inside with the bearing of the main piston rod (7), which receives the impulse of the impact, and at its outlet is, via a non-return valve (3), connected to a hydropneumatic cylinder (8, 10), its hydraulic section (8) separated from the pneumatic section (10) with a separator, which preferably serves as the piston rod (9) between the hydraulic section and the pneumatic section and cooperates with the agent flowing through the confusor (4). The confusor (4), the main hydraulic cylinder (6), and the hydropneumatic cylinder (8,10) are arranged coaxially, or at an angle, preferably the right angle. The device may be used as a car brake mechanism receiving the impact of sudden braking, or a mechanism to assist the car engine crankshaft drive, or a mechanism to assist the compression in a compressor.

The invention concerns a device to convert the impact energy of a car bumping into an obstruction or another vehicle, designed particularly for a car bumper. The device may also be used to convert the impact energy of sudden vehicle braking, or to assist the crankshaft drive in a car engine, or to assist the compression in a compressor.

Known from patent specification U.S. Pat. No. 5,593,195 is an impact moderating mechanism for automobiles comprising a pair of identical, bump absorbing and transferring devices respectively equipped at two ends of a chassis. Each of the devices comprises an outer bumper and two pairs of hydraulic cylinders mutually connected with numerous conduits. The devices mounted on one end of the vehicle can absorb some of the energy released from crash and then transfer much of the energy to the devices on the opposite end of the vehicle, where it is eliminated.

Known from patent specification PL 196362 B1 is a safe car bumper comprising a set of springs and a hydraulic system of piston-fitted cylinders, combined with safety valves and a latch device, thanks to which the bumper spring set absorbs the energy and at the same time blocks the instant rebound of the absorbed energy.

Also, known from the description contained in patent application P.358597 is a hydraulic rebound bumper with a working cylinder filled with working fluid and a sliding piston fitted therein, where a rebound stroke valve is connected to the piston rod, which slides through the shock absorber along piston rod guides. There is a pad inside the cylinder, with at least one surface co-operating with the inlet side of the conduits of the piston rebound stroke valve, the pad fixed to the spring element on one end, and mounted at the piston rod guide on the other end.

The known solutions fail to mitigate the bump effects sufficiently, if the crashing vehicle travels at high speeds.

The present invention solves the problem of immediate absorption of the energy released at the time an object, particularly a speeding car, hits an obstruction or brakes suddenly, and in effect reduces the impact of the inertial force to a substantial extent.

The problem has been solved by designing a mechanism where the energy released at the time when a fast moving object hits an obstruction or brakes suddenly is absorbed by a working agent, then transferred to an absorber, which accumulates the energy and finally disperses it.

The invention further offers a solution to the issue of economic fuel consumption in car engines, and addresses environment protection by reducing fume emission. The problem was solved by utilising the energy released in effect of cyclical rapid thrusts caused by pressure changes between individual engine cylinders to assist the engine crankshaft drive.

Also the invention further offers a solution to the aid the compression in a compressor. The problem was solved by utilising the energy released in effect of cyclical rapid thrusts caused by pressure changes between individual compressor cylinders to assist the compression in a compressor.

An impact energy conversion device according to this invention is characterised in that it has cylinders and at least one confusor, where each confusor is, at its inlet, connected to a hydraulic cylinder fitted inside with the bearing of the main piston rod, which receives the impulse of the impact, and at its outlet is, via a non-return valve, connected to a hydropneumatic cylinder, its hydraulic section separated from the pneumatic section with a separator, which cooperates with the agent flowing through the confusor.

Preferably, the separating function is performed by the piston rod, its bearing fitted inside the hydropneumatic cylinder between the hydraulic and pneumatic sections thereof.

Preferably, the main and/or the separator piston rods are jug-shaped.

In another variant of the solution, a mobile piston is additionally fitted in the main piston rod, preferably mounted on a spring element such as a mechanical or gas spring.

In variant one of the invention the confusor and the main hydraulic cylinder are arranged coaxially.

In another variant of the invention the confusor axis runs at angle 0°<α<180°, preferably the right angle, to the axis of the main hydraulic cylinder.

In the event two or more confusors are used, they are, at the inlet, connected to the main hydraulic cylinder, preferably via a duct.

Preferably, the device has two coaxially arranged confusors.

In embodiment one of the invention, the confusor and the hydropneumatic cylinder are arranged coaxially.

In another embodiment of the invention, the confusor axis runs at angle 0°<β<180°, preferably the right angle, to the axis of the hydropneumatic cylinder.

In the event the confusor is arranged at angle a to the axis of the main hydraulic cylinder, the main piston rod is equipped with auxiliary guiding piston rod.

Preferably, the confusor walls converge at 8° to 16°, and/or the ratio between the confusor cross-section area at the inlet and its cross-section area at the outlet ranges from 1:5 to 1:12, preferably 1:10.

Preferably too, the main piston rod and/or the piston rod serving as the separator inside the hydropneumatic cylinder, are sealed at their bearings with a resilient metal gasket in the form of a cylindrical ring, L-shaped in cross-section, its inner edge finished with a sealing lip, which regulates the clearance between the sealed surfaces when under pressure from the direction opposite to the sealing lip.

Preferably, the piston mounted in the main piston rod and/or the piston serving as the separator in the hydropneumatic cylinder, are sealed inside the cylinder with a resilient metal gasket in the form of a cylindrical ring, L-shaped in cross-section, its inner edge finished with a sealing lip, which regulates the clearance between the sealed surfaces when under pressure from the direction of the sealing lip.

The device described above is applied as a car bumper mechanism, wherein the main piston rod receives the impact of bumping into an obstruction or another vehicle, and the converted energy of the impact is accumulated in the pneumatic section of the cylinder, and then dispersed.

Also, the device may be applied as a car brake mechanism, wherein the main piston rod receives the impact from the car wheel released during sudden braking, and the converted energy of the impact is accumulated in the pneumatic section of the cylinder, and then dispersed.

Also, the device may be applied as a mechanism to assist the crankshaft drive in a car engine, wherein the main piston rod receives cyclical thrusts caused by pressure changes between individual engine cylinders, and the converted energy of the thrusts is cyclically transmitted to the proper engine cylinder, or as a mechanism to assist the compression in a compressor, wherein the main piston rod receives cyclical thrusts caused by pressure changes between individual compressor cylinders, and the converted energy of the thrusts is cyclically transmitted to the proper compressor cylinder.

The device is then built into the engine or compressor cylinder system.

Thanks to the immediate accumulation of the impact of a bump or sudden braking the device according to the invention, when used in a car bumper, ensures that the impact of the inertial force on car passengers, the car itself, and the objects inside it is minimised.

Exemplary embodiments of the invention are illustrated on the drawing, where:

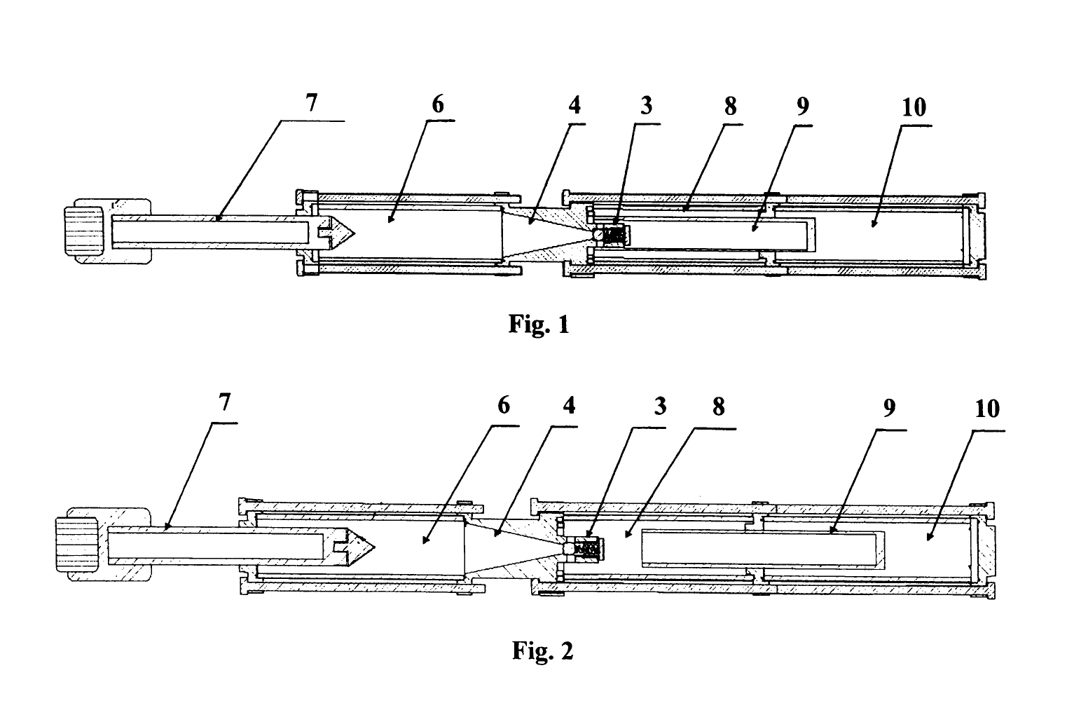

FIG. 1 presents an axial cross-section of the device in the embodiment variant with one confusor arranged coaxially to the main cylinder and the hydropneumatic cylinder shown in its initial position before the bump,

FIG. 2 shows an axial cross-section of the device as illustrated on FIG. 1, in its ultimate position after the bump,

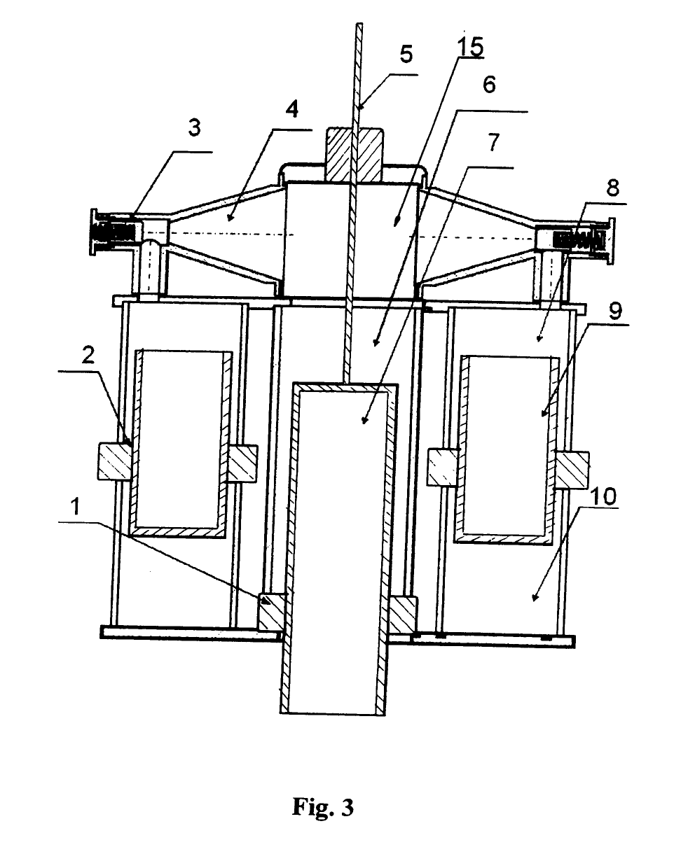

FIG. 3 presents an axial cross-section of the device in the embodiment variant with two confusors arranged coaxially to each other, but at the right angle to the main cylinder and the hydropneumatic cylinder cooperating with the specific confusor,

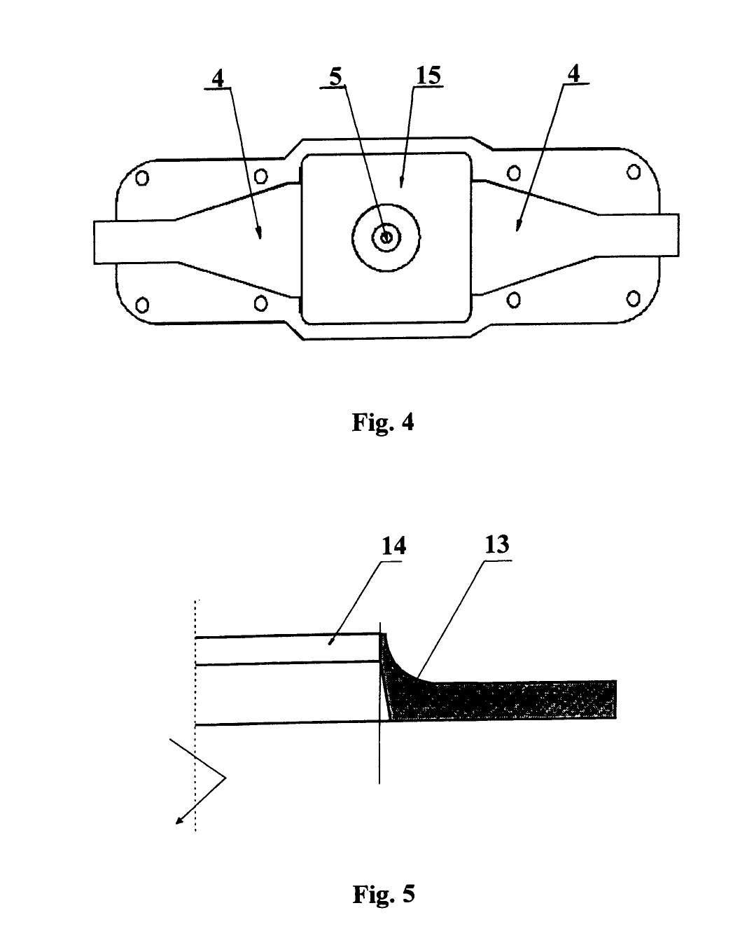

FIG. 4 presents an aerial view of the device, as illustrated on FIG. 3,

FIG. 5 shows a cross-section of the gasket sealing the piston rods according to the variant illustrated on FIG. 4,

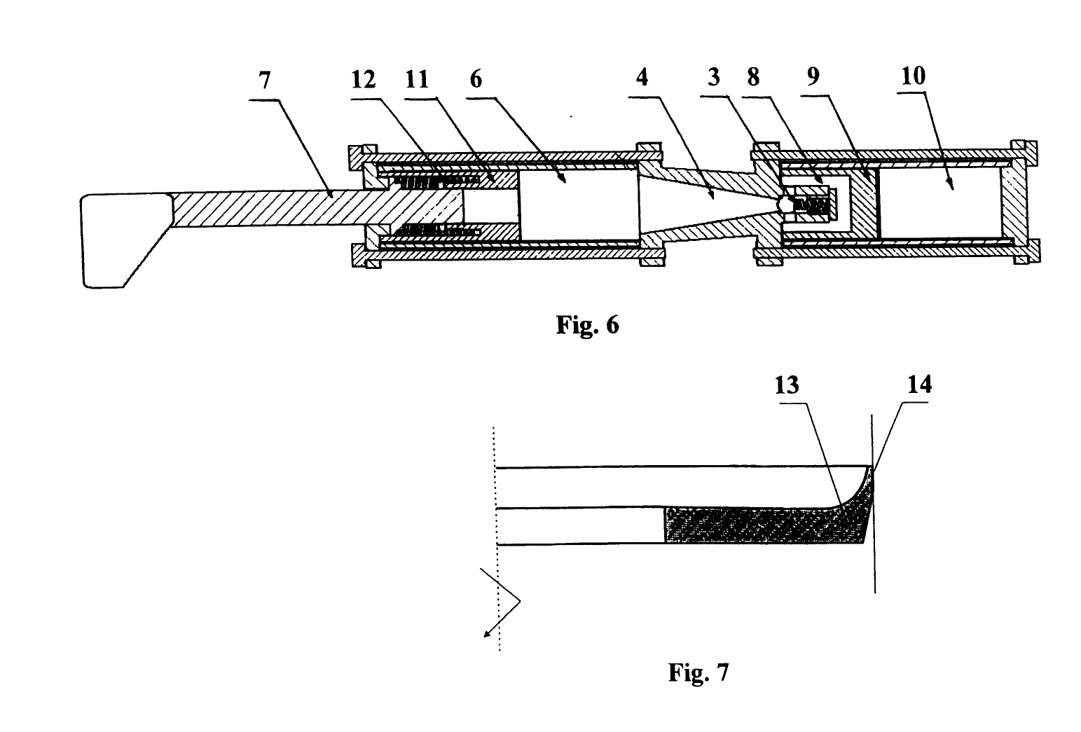

FIG. 6 presents an axial cross-section of the device in its initial position, in the embodiment variant with one confusor arranged coaxially to the main cylinder and the hydropneumatic cylinder. The main piston rod is fitted inside with a mobile piston set on a spring, and the piston inside the hydropneumatic cylinder serves as the separator.

FIG. 7 shows a cross-section of the gasket sealing the pistons in the cylinders according to the variant illustrated on FIG. 6.

According to the exemplary embodiment of the invention shown on FIG. 1 and FIG. 2, the device used as the bumper or brake mechanism has one confusor 4 connected at the inlet to the main hydraulic cylinder 6, which is fitted inside with the bearing of the main piston rod 7, where the piston rod, hollow so as to reduce its weight, receives the impulse of the bump or rapid braking, and the same confusor 4 is at the outlet connected via a non-return valve 3 to the hydropneumatic cylinder 8, 10, its hydraulic section 8 and pneumatic section 10 separated with the bearing-set piston rod 9, jug-shaped to reduce its weight and co-operating with the agent flowing through the confusor 4. The main hydraulic cylinder 6, confusor 4, and the hydropneumatic cylinder 8,10 are all arranged coaxially.

According to the exemplary embodiment of the invention shown on FIG. 3 and FIG. 4, the device used as the bumper or brake mechanism has two coaxially arranged confusors 4, each connected at the inlet to the main hydraulic cylinder 6 via a duct 15, and each connected at the outlet to a hydropneumatic cylinder 8, 10 via a non-return valve 3. The axes of the confusors 4 run at the right angle to the axis of the main cylinder 6 and to the axes of the hydropneumatic cylinders 8, 10. The main cylinder 6 is fitted with a bearing-set main piston rod 7, hollow so as to reduce its weight, which receives the impulse of the bump or rapid braking, and the hydropneumatic cylinder 8, 10 is fitted with a bearing-set piston rod 9 separating its hydraulic section 8 and pneumatic section 10, jug-shaped to reduce its weight and co-operating with the agent flowing through the confusor 4. The main piston rod 7 is equipped with auxiliary guiding piston rod 5 so as to ensure its axial movement.

Preferably, the bearings of the piston rods 7, 9 inside the respective cylinders 6, 8, and 10 are linear, and are preferably sealed therein with a resilient metal gasket in the form of a cylindrical ring 13, L-shaped in cross-section, its inner edge finished with a sealing lip 14, as presented on FIG. 5. In order to regulate the clearing between the sealed surfaces, the ring 13 is subject to pressure from the direction opposite to the sealing lip 14. Preferably, the confusor walls converge at 8° to 16°, and/or the ratio between the confusor cross-section area at the inlet and its cross-section area at the outlet ranges from 1:5 to 1:12, preferably 1:10.

According to the exemplary embodiment of the invention shown on FIG. 6, the device used as the bumper or brake mechanism has one confusor 4 connected at the inlet to the main hydraulic cylinder 6 fitted inside with the bearing of the main piston rod 7, which receives the impulse of the bump or rapid braking, and the same confusor 4 is at the outlet connected via a non-return valve 3 to the hydropneumatic cylinder 8, 10. The main piston rod 7 is fitted inside with a mobile piston 11 set on a spring 12. The piston 9 inside the hydropneumatic cylinder 8, 10 serves as the separator, and the agent flowing through the confusor 4 serves as the piston rod. The main hydraulic cylinder 6, the confusor 4, and the hydropneumatic cylinder 8,10 are all arranged coaxially.

Preferably, each of: piston 11 and piston 9, the latter serving as the separator in the hydropneumatic cylinder, is sealed in its respective cylinder 6, and 8,10 with a resilient metal gasket in the form of a cylindrical ring 13, L-shaped in cross-section, its outer edge finished with a sealing lip 14, as shown on FIG. 7. In order to regulate the clearance between the sealed surfaces, the ring 13 is subject to pressure from the direction of the sealing lip 14. Preferably, the confusor walls converge at 8° to 16°, and/or the ratio between the confusor cross-section area at the inlet and its cross-section area at the outlet ranges from 1:5 to 1:12, preferably 1:10.

In each embodiment of the invention according to the patent claims, the main piston rod 7 receives the impulse of the bump and transfers it to the hydraulic agent causing its sudden shift towards the confusor(s) 4. The hydraulic agent under the high pressure opens the non-return valve 3 in the confusor 4, and the agent flows into the hydraulic section 8 of the hydropneumatic cylinder shifting the piston rod 9 into the pneumatic section 10 of the same cylinder, or—in another version of the invention—shifting the piston 9 and thus causing accumulation of the bump-released energy in the pneumatic section 10 of the cylinder, whereupon the energy is either dispersed (in the event the device is used as a bumper or brake mechanism), or transmitted to the appropriate engine cylinder (if the device is used as a mechanism to assist the crankshaft drive), or transmitted to the appropriate compressor cylinder (if the device is used as a mechanism to assist the compression).

Experiments have proven that a resilient metal gasket in the form of a cylindrical ring 13, L-shaped in cross-section, its outer or inner edge finished with a sealing lip 14, when subject to pressure as appropriate to regulate the clearance between the sealed surfaces, ensures proper tightening of the system subject to very high pressures and reduces friction.

1. An impact energy conversion device, characterised in that it has cylinders and at least one confusor, where each confusor (4) is, at its inlet, connected to the main hydraulic cylinder (6) fitted inside with the bearing of the main piston rod (7), which receives the impulse from an impact, and at its outlet is, via a non-return valve (3), connected to a hydropneumatic cylinder (8,10), its hydraulic section (8) separated from the pneumatic section (10) with a separator, which cooperates with the agent flowing through the confusor (4).

2. The device as claimed in claim 1, characterised in that the separator serves as the piston (9) inside the hydropneumatic cylinder (8,10) between the hydraulic section (8) and the pneumatic section (10).

3. The device as claimed in claim 1, characterised in that the main piston rod (7) and/or the separator piston rod (9) are jug-shaped.

4. The device as claimed in claim 1, characterised in that the separator serves as the piston (9) inside the hydropneumatic cylinder.

5. The device as claimed in claim 1, characterised in that the main piston rod (7) is fitted inside with a mobile piston (11).

6. The device as claimed in claim 5, characterised in that the piston (11) is mounted in the main piston rod (7) on a spring element (12), preferably a mechanical or gas spring.

7. The device as claimed in claim 1, characterised in that the confusor (4) and the main hydraulic cylinder (6) are arranged coaxially.

8. The device as claimed in claim 1, characterised in that the axis of the confusor (4) runs at angle 0°<α<180°, preferably the right angle, to the axis of the main hydraulic cylinder (6).

9. The device as claimed in claim 8, characterised in that the confusors (4) are each connected at the inlet to the main hydraulic cylinder (6) via a duct (15).

10. The device as claimed in claim 9, characterised in that it has two confusors (4) arranged coaxially.

11. The device as claimed in claim 1, characterised in that the confusor (4) and the hydropneumatic cylinder (8, 10) are arranged coaxially.

12. The device as claimed in claim 1, characterised in that the confusor (4) axis runs at angle 0°<β<180°, preferably the right angle, to the axis of the hydropneumatic cylinder.

13. The device as claimed in claim 8, characterised in that the main piston rod (7) is equipped with auxiliary guiding piston rod (5).

14. The device as claimed in claim 1, characterised in that the confusor (4) walls converge at 8° to 16°.

15. The device as claimed in claim 1, characterised in that the ratio between the confusor (4) cross-section area at the inlet and its cross-section area at the outlet ranges from 1:5 to 1:12, preferably 1:10

16. The device as claimed in claim 1, characterised in that the main piston rod (7) and/or the piston rod (9) serving as the separator are sealed in their bearings (1, 2) with a resilient metal gasket in the form of a cylindrical ring (13), L-shaped in cross-section, its inner edge finished with a sealing lip (14), which regulates the clearance between the sealed surfaces when under pressure from the direction opposite of the sealing lip (14).

17. The device as claimed in claim 4, characterised in that the piston (11) and/or the piston (9) serving as the separator are sealed in their cylinders with a resilient metal gasket in the form of a cylindrical ring (13), L-shaped in cross-section, its inner edge finished with a sealing lip (14), which regulates the clearance between the sealed surfaces when under pressure from the direction of the sealing lip (14).

18. The device as claimed in claim 1, characterised in that it is applied as a car bumper mechanism, wherein the main piston rod (7) receives the impact of bumping into an obstruction or another vehicle, and the converted energy of the impact is accumulated in the pneumatic section (10) of the cylinder, and then dispersed.

19. The device as claimed in claim 1, characterised in that it is applied as a car brake mechanism, wherein the main piston rod (7) receives the impact from the car wheel released during sudden braking, and the converted energy of the impact is accumulated in the pneumatic section (10) of the cylinder, and then dispersed.

20. The device as claimed in claim 1, characterised in that it is applied as a mechanism to assist the crankshaft drive in a car engine, wherein the main piston rod (7) receives cyclical thrusts caused by pressure changes between individual engine cylinders, and the converted energy of the thrusts is cyclically transmitted to the proper engine cylinder.

21. The device as claimed in claim 1, characterised in that it is applied as a mechanism to assist the compression in a compressor, wherein the main piston rod (7) receives cyclical thrusts caused by pressure changes between individual compressor cylinders, and the converted energy of the thrusts is cyclically transmitted to the proper compressor cylinder.
